(19) United States
(12) Patent Application Publication
(10) Pub. No.: US 2014/0155127 A1
(43) Pub. Date: Jun. 5, 2014

(54) Envelope Tracker Path Adaptation for Power Saving

(71) Applicant: Broadcom Corporation, Irvine, CA (US)

(72) Inventors: Sriraman Dakshinamurthy, San Jose, CA (US); Robert Gustav Lorenz, Menlo Park, CA (US)

(21) Appl. No.: 13/922,813

(22) Filed: Jun. 20, 2013

Related U.S. Application Data
(60) Provisional application No. 61/732,780, filed on Dec. 3, 2012.
(60) Provisional application No. 61/804,831, filed on Mar. 25, 2013.

(51) Int. Cl. H04W 52/02

(52) U.S. Cl. CPC H04W 52/028
USPC 455/574

(57) ABSTRACT

In response to changing power output requirements of a UE, an envelope tracking (ET) path of a transmission chain changes power modes. When the UE output power is below a threshold, the ET path may switch an ET power supply to a low power mode. With the switch to low power mode, the UE may also set one or more of the other components in the ET path to a low power mode of operation to save additional power.

### CROSS REFERENCE TO RELATED APPLICATIONS

This application claims priority to U.S. Provisional Application Ser. No. 61/732,780, filed 3 Dec. 2012, which is incorporated by reference in its entirety. This application also claims priority to, and incorporates by reference, U.S. Provisional Application Ser. No. 61/804,831, filed 25 Mar. 2013.

### TECHNICAL FIELD

This disclosure relates to signal transmission. This disclosure also relates to the transmit circuitry in user equipment such as cellular telephones and other devices.

### BACKGROUND

Rapid advances in electronics and communication technologies, driven by immense customer demand, have resulted in the widespread adoption of mobile communication devices. The extent of the proliferation of such devices is readily apparent in view of some estimates that put the number of wireless subscriber connections in use around the world at over 85% of the world's population. Furthermore, past estimates have indicated that (as just three examples) the United States, Italy, and the UK have more mobile phones in use in each country than there are people even living in those countries. Improvements in wireless communication devices, particularly in their ability to reduce power consumption, will help continue to make such devices attractive options for the consumer.

### BRIEF DESCRIPTION OF THE DRAWINGS

The techniques described below may be better understood with reference to the following drawings and description. In the figures, like reference numerals designate corresponding parts throughout the different views.

FIG. 1 shows an example of user equipment that includes a transmit and receive section.

FIG. 2 is an example of a transmit and receive section.

FIG. 3 shows an example of output power mode transitions.

FIG. 4 shows a state diagram for changing output power modes.

FIG. 5 shows an example of reconfiguring an envelope tracking path for a lower power mode.

FIG. 6 shows an example of logic for reconfiguring an envelope tracking path for a lower power mode.

FIG. 7 shows a second example of reconfiguring an envelope tracking path for a lower power mode.

FIG. 8 shows an example of logic for reconfiguring an envelope tracking path for a lower power mode.

### DETAILED DESCRIPTION

The discussion below makes reference to user equipment (UE). UE may take many different forms and have many different functions. As one example, UE may be a 2G, 3G, or 4G/LTE cellular phone capable of making and receiving wireless phone calls, and transmitting and receiving data. The UE may also be a smartphone that, in addition to making and receiving phone calls, runs any number or type of applications. UE may be virtually any device that transmits and receives information, including as additional examples a driver assistance module in a vehicle, an emergency transponder, a pager, a satellite television receiver, a networked stereo receiver, a computer system, music player, or virtually any other device. The techniques discussed below may also be implemented in other devices, such as a base station or other network controller that communicates with the UE.

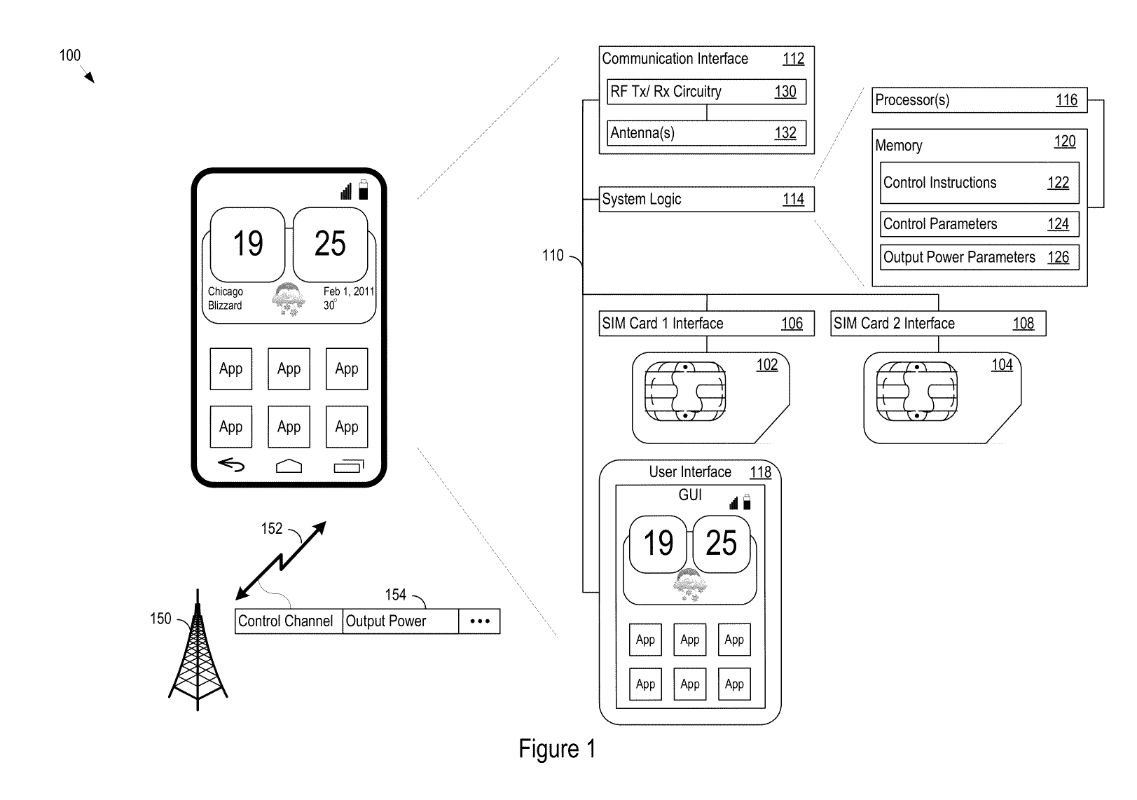

Turning now to FIG. 1, that figure shows an example of a UE 100 in communication with a network controller 150, such as an enhanced Node B (eNB) or other base station. In this example, the UE 100 supports one or more Subscriber Identity Modules (SIMs), such as the SIM1 102 and the SIM2 104. Electrical and physical interfaces 106 and 108 connect SIM1 102 and SIM2 104 to the rest of the user equipment hardware, for example, through the system bus 110.

The user equipment 100 includes a communication interface 112, system logic 114, and a user interface 118. The system logic 114 may include any combination of hardware, software, firmware, or other logic. The system logic 114 may be implemented, for example, in a system on a chip (SoC), application specific integrated circuit (ASIC), or other circuitry. The system logic 114 is part of the implementation of any desired functionality in the UE 100. In that regard, the system logic 114 may include logic that facilitates, as examples, running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 118. The user interface 118 may include a graphical user interface, touch sensitive display, voice or facial recognition inputs, buttons, switches, speakers and other user interface elements.

In the communication interface 112, Radio Frequency (RF) transmit (Tx) and receive (Rx) circuitry 130 handles transmission and reception of signals through the antenna(s) 132. The communication interface 112 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

As one implementation example, the communication interface 112 and system logic 114 may include a BCM2091 EDGE/HSPA Multi-Mode, Multi-Band Cellular Transceiver and a BCM59056 advanced power management unit (PMU), controlled by a BCM28150 HSPA+ system-on-a-chip (SoC) baseband smartphone processer or a BCM25331 Athena (TM) baseband processor. These devices or other similar system solutions may be extended as described below to provide the additional functionality described below. These integrated circuits, as well as other hardware and software implementation options for the user equipment 100, are available from Broadcom Corporation of Irvine Calif.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interface 112 may support transmission and reception under the 4G/Long Term Evolution (LTE) standards. The techniques described below, however, are applicable to other communications technologies whether arising from the 3rd Generation Partnership Project (3GPP), GSM (R) Association, Universal Mobile Telecommunications System (UMTS), High Speed Packet Access (HSPA)+, or other partnerships or standards bodies.

The system logic 114 may include one or more processors 116 and memories 120. The memory 120 stores, for example, control instructions 122 that the processor 116 executes to carry out any of the processing or control functionality described below, operating in communication with the circuitry in the communication interface 112. For example, the system logic 114 may reprogram, adapt, or modify parameters or operational characteristics of the logic in the communication interface 112 and in the system logic 114 itself. The system logic 114 may make adaptations to, as a specific example, a shaping table, whether the shaping table is implemented in or by the system logic 114 or in or by the communication interface 112.

The control parameters 124 provide and specify configuration and operating options for the control instructions 122. As will be explained in more detail below, the memory 120 may also store output power parameters 126. More specifically, the memory 120 may parameters that determine the output power level of the UE 100. The UE 100 may receive such parameters from the network controller 150, for example.

As noted above, the UE 100 is in communication with the network controller 150 over one or more control channels 152. The network controller 150 sends messages to the UE 100 over the control channels 152. The messages may include operating parameters 154, such as power control parameters, bandwidth allocation parameters, and other operating parameters. The network controller 150 generally commands the UE 100 to produce certain output powers, as the network controller 150 sees fit to meet any particular communication goals.

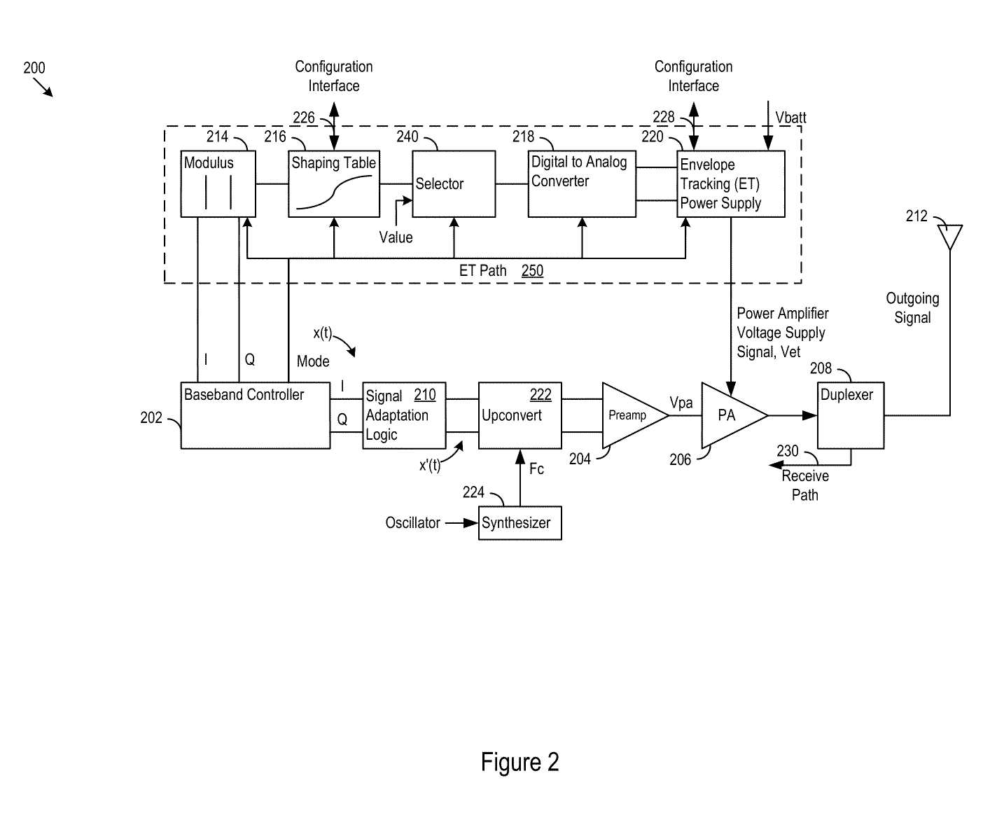

FIG. 2 shows an example of transmit/receive logic 200 that may be present in the user equipment 100. The logic 200 may be implemented by any combination of a baseband controller, Radio Frequency (RF) Integrated Circuit (IC), power amplifier, and envelope tracking power supply, and other circuitry. Accordingly, the logic 200 may map to one or more portions of the communication interface 112 and the system logic 114.

In the example in FIG. 2, the logic 200 includes a baseband controller 202, a power amplifier (PA) driver 204, a power amplifier (PA) 206, and a duplexer 208. Signal adaptation logic 210 is also present, and may be implemented as digital pre-distortion (DPD) logic. The PA driver 204 acts as a driver in the sense that it generates the RF signal that drives the input to the PA 206. The PA driver 204 may, for example, produce a wide range of output powers for further amplification by the PA 206. The range of transmit powers at the antenna 212 may be, as one example, −40 dBm to +23 dBm, with the PA 206 able to provide up to some nominal amount of gain, e.g., up to 26-30 dBm of gain, depending on the Vet voltage supply input to the PA 206. The PA driver 204 may be part of an RFIC between the baseband controller 202 and the PA 206, and the RFIC may also include an upconversion section 222, filters, and other processing logic.

The upconversion section 222 may center the signal to be transmitted at a particular center frequency Fc. Different center frequencies for transmitting and for receiving may be specified over a control channel by the network controller 150 (for example), and may be internally generated by a frequency synthesizer 224 for upconversion and downconversion in the logic 200. The upconversion section 222 may implement a processing flow for the input signal samples that includes, as examples, a pre-emphasis or baseband gain stage, I and Q DACs, analog filters, and mixers for upconversion to Fc. Pre-amplification by the PA driver 204, and power amplification by the PA 206 follow the upconversion section 222.

The duplexer 208 may implement a transmit/receive switch under control of the system logic 114, e.g., under control of the baseband controller 202. In one switch position, the duplexer 208 passes amplified transmit signals from the PA 206 through the antenna 212. In a different switch position, the duplexer 208 passes received signals from the antenna 212 to the receive path 230 for further processing.

The baseband controller 202 may be part of the system logic 114. The baseband controller 202 provides, e.g., inphase/quadrature (I/Q) signal samples of a desired transmit signal to an envelope tracker (ET) path 250. The ET path 250 may include the modulus logic 214, which determines the absolute value (e.g., the square root of I squared plus q squared) of the transmit signal to a shaping table 216. The shaping table 216 maps input values to output values in a linear or non-linear manner. Said another way, the shaping table 216 implements a non-linear mapping between the modulus of the signal to be transmitted and the voltage that appears at the output of the DAC 218, to which the ET switcher is responsive. The output of the shaping table 216 feeds the digital to analog converter (DAC) 218. In turn, the DAC 218 outputs the envelope of the transmit signal as modified by the shaping table as a reference input signal to the envelope tracking (ET) power supply 220.

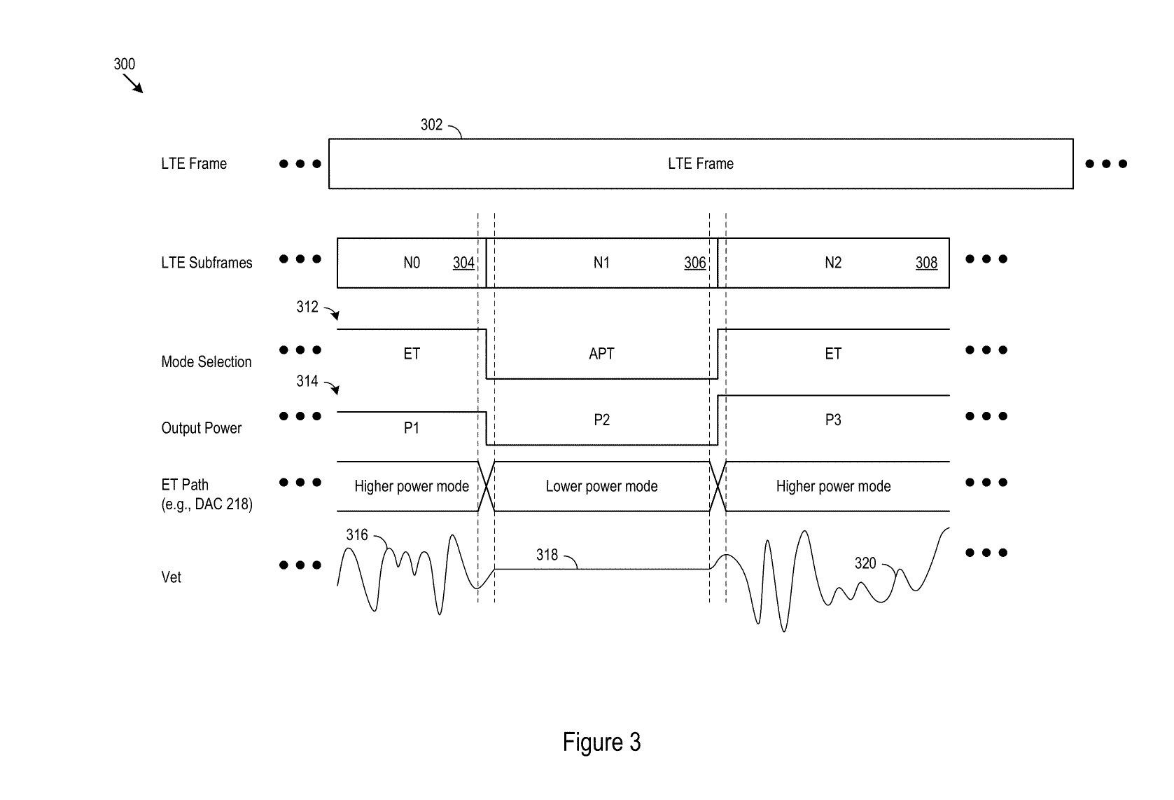

In some implementations, the ET path 250 may also include a selector 240, e.g., a multiplexer. The selector 240 may choose between multiple inputs, e.g., according to a selection input such as a signal that reflects the power output mode (See FIG. 3). The selector 240 provides the selected output to the DAC 218. In the example in FIG. 2, the inputs to the selector 240 are the shaping table outputs, and a value, e.g., a constant DC value. Accordingly, when the mode switches to a lower power APT mode, then the selector 240 may output the value, resulting in the DAC producing a constant DC voltage for the ET power supply 220. At the same time, any of the other components of the ET path 250 may respond to the low power mode selection signal and enter low power modes. For example, the DAC 218 may enter a lower power mode that is nevertheless sufficient to accurately generate a DC output voltage.

The shaping table 216 may be implemented in many ways. For example, the shaping table 216 may be a lookup table implemented in software or hardware, as part of the baseband controller 202, or as a separate circuit. The shaping table 216 may include, for instance, 64 or 128 table data set values that represent an input/output relationship for mapping input signal values to output signal values. The shaping table implementation may perform linear or non-linear interpolation between specific data set values, for any input signal value that does not exactly correspond to one of the sample points having a specific data set value in the shaping table 216. In other implementations, the shaping table 216 may be implemented as program instructions that calculate the output value as a function of input signal value according to any desired input to output relationship curve.

An ET power supply 220 receives the reference envelope signal from the DAC 218. The ET power supply 220 may output a PA power supply voltage signal that approximately follows the envelope signal and that may include a variable amount of headroom above the envelope signal. The PA power supply voltage signal, Vet, provides power to the PA 206 for driving the antenna 212 with the transmit signal that results from amplifying the PA 206 input, Vpa.

Note that the logic 200 may support a wide range of output powers. The output power employed at any particular time may be specified by the network controller 150, for example. In some implementations, the logic 200 may generate output powers at the antenna 212 between −40 dBm and +23 dBm. As noted above, the duplexer 208 may separate the transmit path and receive path, and in doing so introduces some power loss, typically on the order of 3 dBm. Thus, to achieve 23 dBm output power at the antenna 212, the PA 206 produces approximately a 26 dBm outgoing signal.

Configuration interfaces 226 and 228, e.g., serial or parallel data interfaces, control pins, or other interfaces, may be provided to configure the shaping table 216 and the ET power supply 220, or other parts of the logic 200. The configuration interfaces 226 and 228 may be Mobile Industry Processor Interface (MIPI) Alliance specified interfaces or other types of interfaces. The interfaces, as examples, may send and receive messages, such as configuration messages, or may act as read/write access interfaces to memory spaces, such as register spaces.

Thus, for example, the ET power supply 220 may include registers that select an operating mode for the ET power supply 220. There may be a wide variety of operating modes supported by the ET power supply 220. Two examples of operating modes include Envelope Tracking (ET) mode, and Average Power Tracking (APT) mode. ET mode generally consumes more power than APT mode, and thus, more generally, the ET power supply 220 may be said to support a low power mode and a high power mode of operation.

In the ET mode, the ET power supply 220 tracks the envelope of the reference input signal from the DAC 218. In particular, the ET power supply 220 outputs a power amplifier voltage supply signal, Vet, that has an envelope that approximates the envelope of the reference input signal. In order to accomplish envelope tracking, tracking circuitry in the ET power supply 220 consumes current to monitor and measure the reference input, and to generate and regulate Vet. For example, the ET power supply 220 may include sampling clocks running at, e.g., 2 to 3 times the bandwidth of the reference input signal, as well as error amplifiers, feedback loops, output drivers, and other circuitry that generates Vet so that Vet follows the envelope of the reference input signal.

In the APT mode, the ET power supply 220 may forgo envelope tracking. In particular, in APT mode, the ET power supply 220 may output a DC voltage as the power amplifier supply voltage, Vet. The level of the DC output voltage may vary according to the output power required out of the PA 206. Greater Vet generally corresponds to greater gain for the PA 206, for meeting whatever output power requirement the UE 100 desires to meet, e.g., an output power specified by the network controller 150.

The PA 206 may be on the order of 40% efficient. Accordingly, the PA 206 would consume almost 1 W of power to apply a 26 dBm gain (about 400 mW) to a 0 dBm input signal driving the PA 206. Envelope tracking consumes power just like any other operation in the UE 100. In many cases, the power cost of envelope tracking is more than offset by the power saving achieved in the PA 206, given its relatively low efficiency, by using envelope tracking, as compared to driving the PA 206 with a fixed DC voltage supply, such as the full battery voltage, Vbatt. For some output powers, however, the cost of envelope tracking, which includes the power cost to run the ET path 250, including the envelope tracking circuitry in the ET power supply 220, may exceed the power saving in the PA 206 resulting from envelope tracking. This may be the case, for example, when relatively low output powers are required from the PA 206.

Other parts of the ET path 250 add significantly to the power cost of envelope tracking. For example, the ET DAC 218 may operate under exacting output requirements, including stringent noise specifications. As a result, the ET DAC 218 may consume a significant amount of power to produce the reference input signal to the ET power supply 220. The ET DAC 218 may also need to support a significant bandwidth at a very low spot noise, such as 10 nV per root Hz. Again, these requirements translate into significant power consumption for the ET DAC 218. As noted above, at lower output powers, the power consumption by the ET path 250 to generate an envelope tracking voltage supply output to the PA 206 may exceed the power saved by using an envelope tracking voltage supply. Accordingly, the discussion below addresses techniques for saving power in such situations.

FIG. 3 shows examples of the ET path 250 transitioning between a higher power mode (e.g., ET mode) and a lower power mode (e.g., APT mode). The examples in FIG. 3 are in the context of an LTE system, but the communication events may be events that occur in any of wide range of communication systems and protocols. FIG. 3 shows an LTE frame 302 and several 1 ms subframes of the LTE frame 302. The subframes shown in FIG. 3 include the subframe 304, 306, and 308.

FIG. 3 also shows how the ET path 250 may change its mode 312 in response to output power changes 314. The output power changes may occur at any interval, and in the example of FIG. 3, they occur on a subframe by subframe basis. In FIG. 3, the UE 100 transitions from output power P1 in subframe 304 to output power P2 in subframe 306 to output power P3 in subframe 308.

In this example, the output power P2 is one at which the cost of envelope tracking (e.g., the power cost for the ET path 250) is more expensive than the savings achieved (e.g., the power savings achieved at the PA 206 by applying an envelope tracking power supply to the PA 206). On the other hand, the relatively high output powers P1 and P3 result in power saving using envelope tracking because envelope tracking for those output powers yields a greater power saving at the PA 206 than the cost of creating the envelope tracking power supply for the PA 206. Accordingly, the UE 100 adapts the ET path for a higher power mode (e.g., ET power mode) at the output powers P1 and P3, and adapts the ET path 250 for a lower power mode (e.g., APT power mode) at the output power P2. Said another way, in response to output power changes, the UE 100 may adapt the ET path 250 to achieve operational characteristics commensurate with the output power.

As a specific example, when ET power mode is applicable, the ET path 250 is actively performing envelope tracking. As shown in FIG. 3, the ET path 250 generates the Vet 316, which approximates the envelope of the reference input to the ET power supply 220. However, in APT power mode, the ET path 250 generates a DC Vet 318 for the PA 206. The level of the DC Vet 318 may vary in proportion to the gain desired for the PA 206. Then, when the output power climbs to P3, the ET path 250 again is actively performing envelope tracking, and again generates a Vet 320 that approximates the envelope of the reference input to the ET power supply 220.

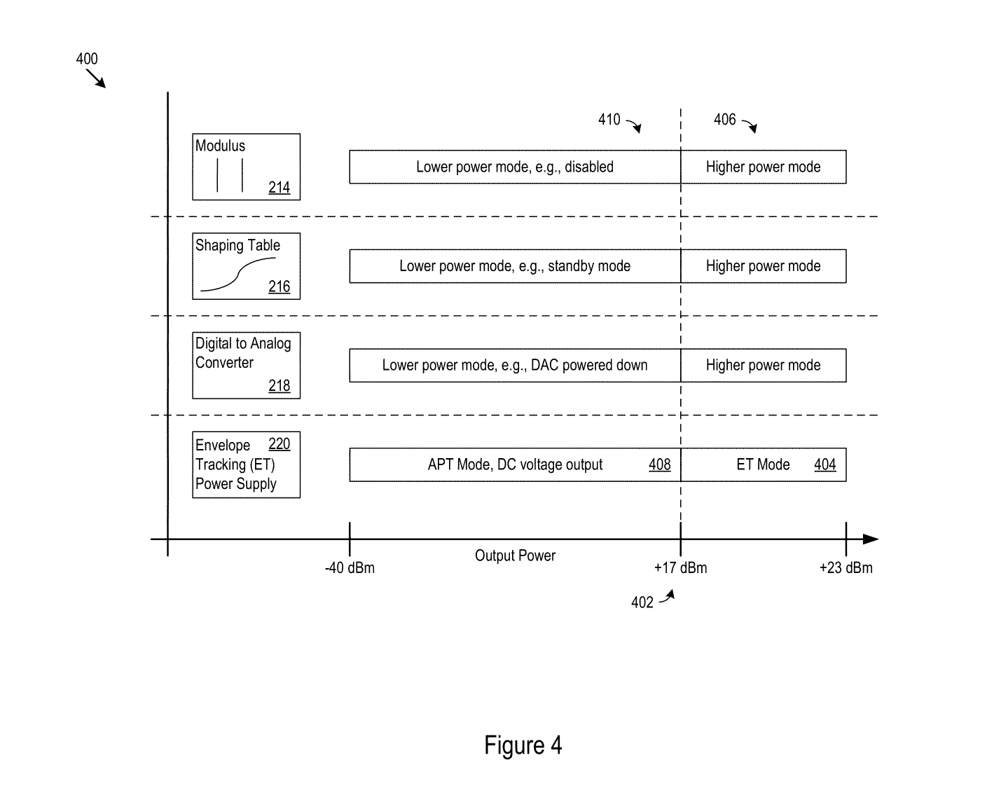

FIG. 4 shows an example state diagram 400 illustrating when the ET path 250 may transition between power modes. FIG. 4 shows the ET path 250 separated out into its components: the modulus section 214, the shaping table 216, the ET DAC 218, and the ET power supply 220. In other implementations, there may be additional, different, or fewer components in the ET path 250, and each may be configured to operate in a different way for any particular power mode. In addition, there may be more power modes than the two power modes shown, and the configuration of each component may vary depending on the power mode currently active. Furthermore, any particular component may make the transition at any particular output power, though FIG. 4 shows the components transitioning at the same output power.

FIG. 4 shows a transition threshold 402 for switching between power modes. In this example, the transition threshold is 17 dBm along a power output range of −40 dBm to 23 dBm at the antenna 212. For output powers above 17 dBm, the ET power supply 220 operates in ET mode 404, and the other components in the ET path 250 operate in their higher power mode 406 to support the normal operation of the ET power supply 220. For instance, the DAC 218 may be powered up and actively producing a very accurate envelope reference signal for the ET power supply 220. For output powers below 17 dBm, the ET power supply 220 operates in APT mode 408, and the other components in the ET path 250 operate in a lower power mode 410. For instance, the DAC 218 and the hardware or software that implements the modulus section 214 and shaping table 216 may be powered down, disabled, placed in standby mode, or otherwise shifted to a lower power mode 410. This may be done in part because the ET power supply 220 no longer needs an accurate envelope reference input signal because the ET power supply 220, in APT mode 408, generates a DC power supply voltage fort the PA 206.

The transition threshold 402 may be set to any of a wide variety of output powers. For example, the transition threshold 402 may be chosen to strategically shift the UE 100 in and out of envelope tracking mode to achieve power savings. For instance, if the ET path 250 requires P mW of power to generate an envelope tracking Vet for the PA 206, and the power saving in the PA 206 (compared to a DC Vet) is at least P mW for output powers greater than T dBm, then the transition threshold may be set at T dBm. For lower output powers, then, the ET path 250 consumes more power than is saved in the PA 206 by using the envelope tracking Vet. Accordingly, for output powers less than T dBm, the ET path 250 may shift to a lower power mode. In the low power mode, the ET power supply 220 may change to APT mode and output a DC voltage supply signal to the PA 206, while some or all of the remaining components of the ET path 250 may also enter low power modes. Thus, although the efficiency of the PA 206 is relatively low, it still may make sense from a power consumption standpoint to operate the PA 206 with a DC voltage supply, take the efficiency hit in the PA 206, and reduce power in the ET path 250 instead.

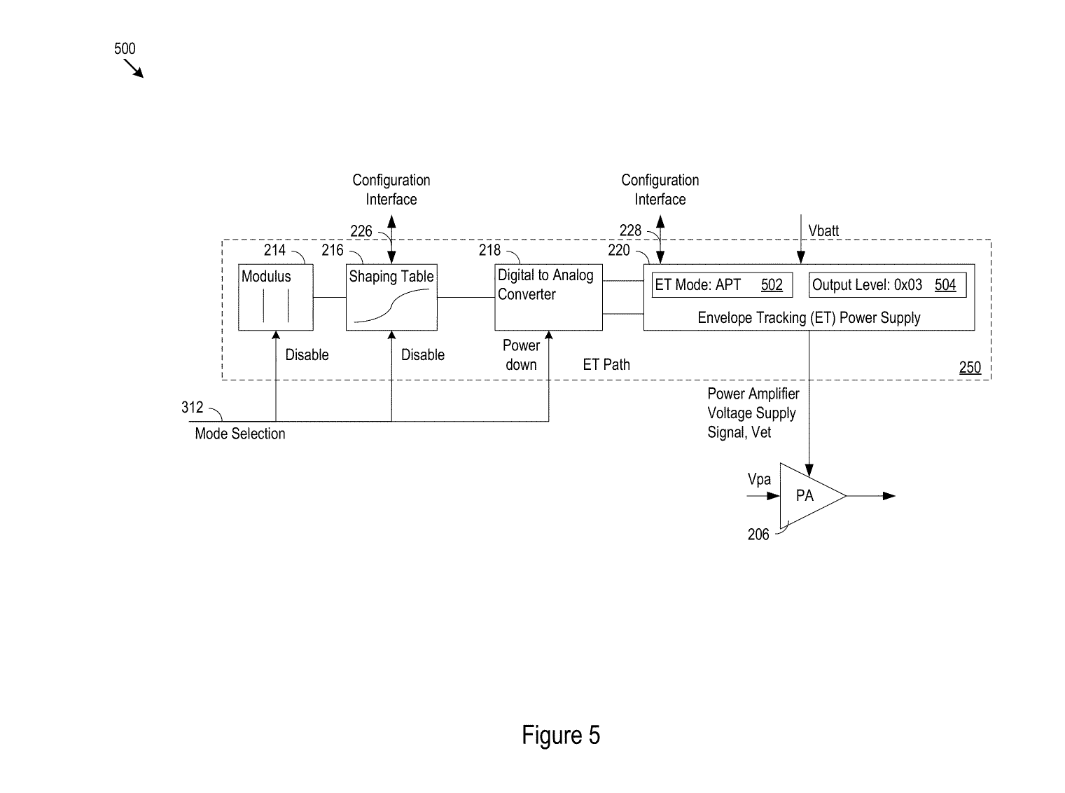

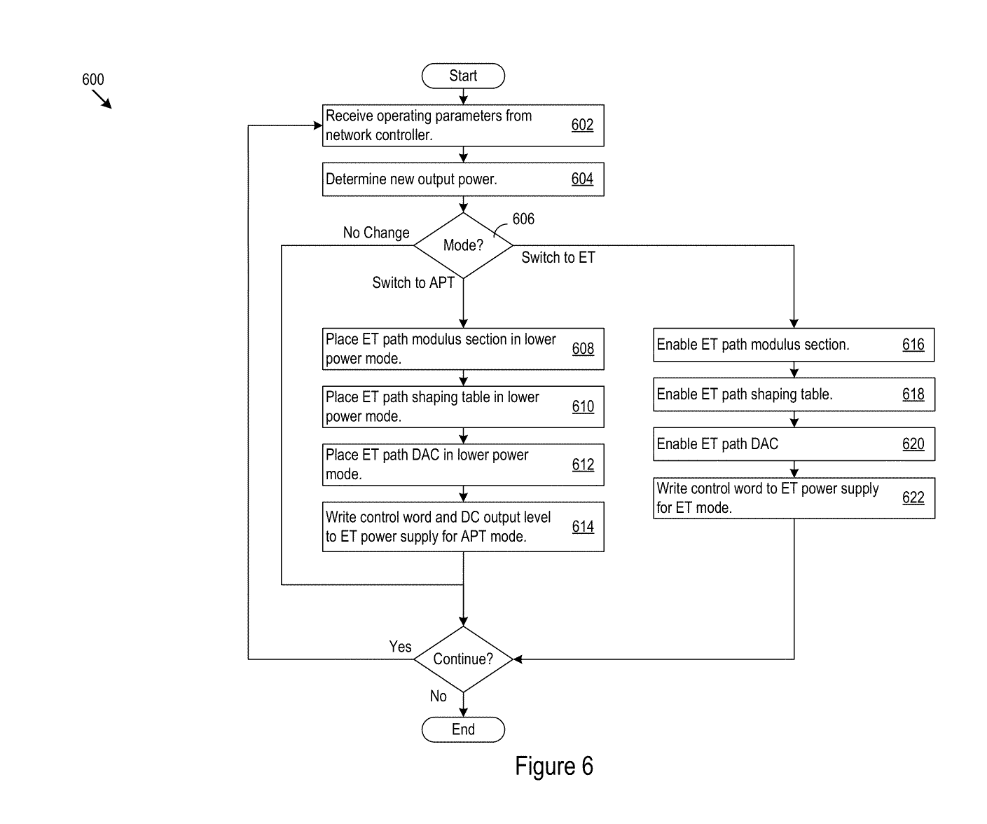

FIG. 5 shows an example 500 of reconfiguring the ET path 250 for a lower power mode. Accompanying FIG. 6 shows an example of logic 600 that may be implemented in hardware or software or both in the UE 100, e.g., in the communication interface 112 and system logic 114, to reconfigure the ET path 250. FIGS. 5 and 6 illustrate an example in which the ET power supply 220 does not require a reference input to the ET power supply 220 when the ET power supply 220 is in APT mode. The logic 600 includes receiving operating parameters from a network controller (602), such as power level parameters, and determining a new output power for the UE 100 (604). When the UE 100 will switch (606) to lower power mode (e.g., APT mode), then the logic 600 may cause one or more components of the ET path 250 to shut down, suspend, become disabled, or power down. In particular, the logic 600 may place the modulus section 214 in a lower power mode (608), place the shaping table 216 in a lower power mode (610), and place the ET DAC 218 in a lower power mode (612). In connection with this type of APT mode, the baseband controller 202 may write control words (e.g., over the MIPI interface 228) to the ET power supply 220 to place the ET power supply 220 in APT mode (614). On the other hand, when switching to a higher power mode (e.g., ET mode), the logic 600 may enable the modulus section 214 (616), shaping table 216 (618), and ET DAC 218 (620). In addition, the logic 600 may write a control word to the ET power supply 220 to place the ET power supply in ET mode (622).

In this context, FIG. 5 shows that the baseband controller 202 has written the APT mode control word into the control register 502. In addition, the baseband controller 202 has written an output level control word into the control register 504. The output level control word specifies to the ET power supply 220 the DC level to produce as the DC voltage supply to the PA 206 while in APT mode. The output level control word will vary according to the desired output power at the antenna 212. FIG. 5 also shows that the other components of the ET path 250 have received a mode selection signal 312 to place the components into a lower power mode.

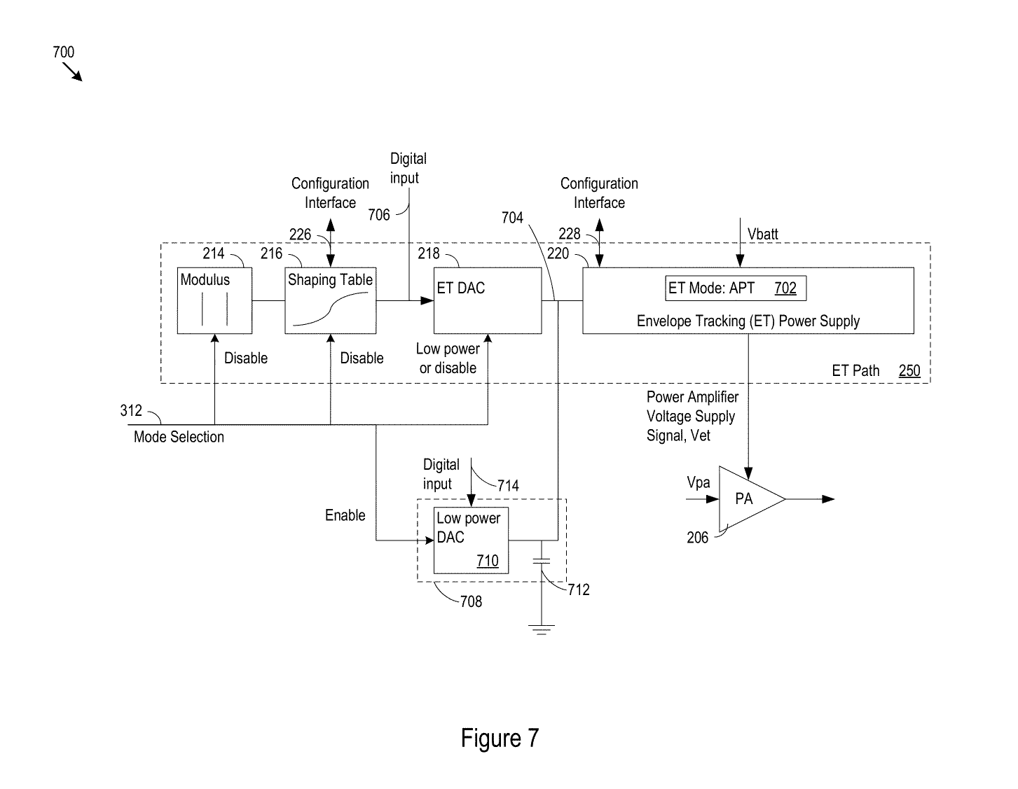

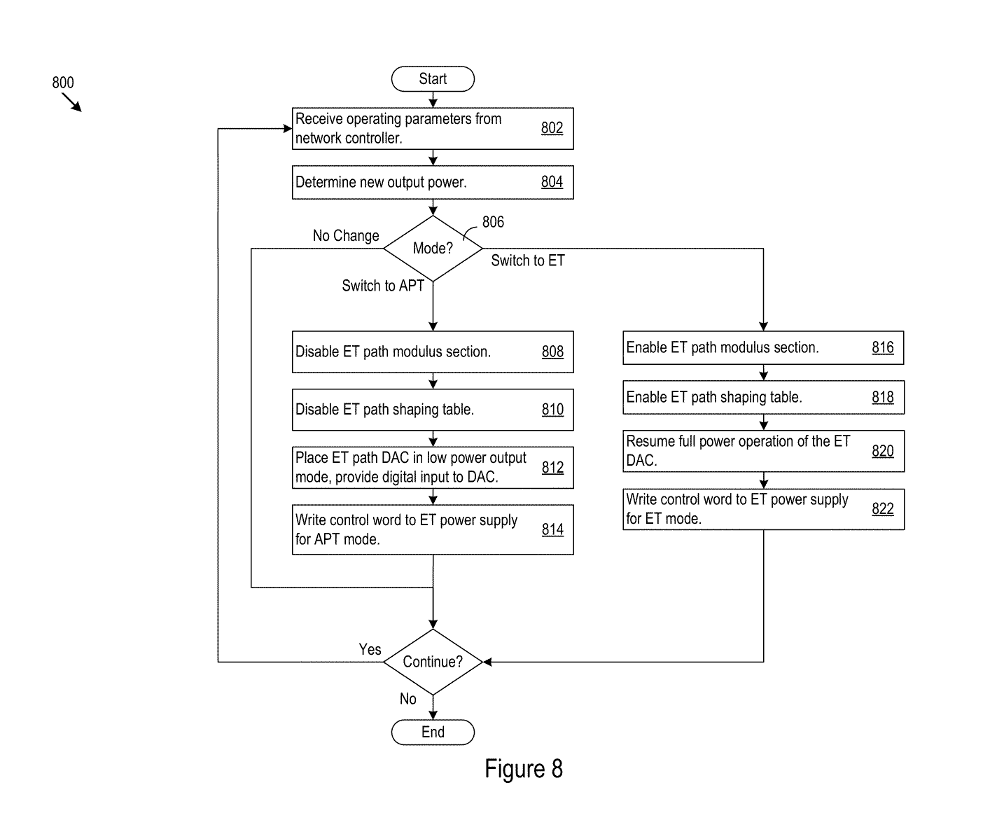

FIG. 7 shows a different example 700 of reconfiguring the ET path 250 for a lower power mode. Accompanying FIG. 8 shows an example of logic 800 that may be implemented in hardware or software or both in the UE 100, e.g., in the communication interface 112 and system logic 114, to reconfigure the ET path 250. FIGS. 7 and 8 illustrate an example in which the ET power supply 220 is of the type that accepts a reference input when the ET power supply 220 is in APT mode. Accordingly, FIG. 7 shows that the baseband controller 202 has written an APT mode control word to the control register 702. However, unlike the example in FIG. 5, there is no separate voltage output level control register, because the ET power supply 220 determines the output DC voltage as a function of a reference input voltage.

The logic 800 includes receiving operating parameters from a network controller (802), such as power level parameters, and determining a new output power for the UE 100 (804). When the UE 100 will switch (806) to lower power mode (e.g., APT mode), then the logic 600 may cause one or more components of the ET path 250 to shut down, suspend, become disabled, or power down. Note, however, that because the ET power supply 220 is assumed to require a reference input, the ET path 250 may be configured to provide that reference input. The reference input may be provided in many different ways, such as by using a DAC to drive the reference input to the ET power supply 220 with the desired reference voltage. Thus, as one example, the logic 600 may disable the modulus section 214 (808) and the shaping table 216 (810). To provide the DC reference input, the logic 800 may place the ET DAC 218 in a low power output mode (812), and may also provide a digital input to the ET DAC 218 representative of the DC reference level needed at the input of the ET power supply 220. Also, in connection with this type of APT mode, the baseband controller 202 may a write control word to the ET power supply 220 to place the ET power supply 220 in APT mode (814). On the other hand, when switching to a higher power mode (e.g., ET mode), the logic 800 may enable the modulus section 214 (816), shaping table 216 (818), and resume full power operation of the ET DAC 218 (820). In addition, the logic 600 may write a control word to the ET power supply 220 to place the ET power supply back into ET mode (822).

In this context, FIG. 7 shows that the baseband controller 202 has written the APT mode control word into the control register 702. Because there is no output level control word, the ET power supply 220 is driven with a DC reference input 704. The DC reference input signal 704 varies according to the desired output power at the antenna 212. The ET power supply 220, in APT mode, responds to the DC reference input signal 704 by producing a DC power supply signal for the PA 206 that is, e.g., proportional to the DC reference input. In some implementations, for example, the DC reference input may vary between 0.8 V and 1.3 V, according to the output power needed at the antenna 212. FIG. 7 also shows that the modulus section 214 and shaping table 216 components of the ET path 250 have received a mode selection signal 312 to place the components into a lower power mode (e.g., by disabling them).

There are many different ways in which the DC reference input signal 704 may be produced. As one example, the ET DAC 218 may support multiple modes of operation, including a high power, high accuracy, low spot noise mode, and a lower power mode. When in the lower power mode, the logic 800 may switch the ET DAC 218 to the lower power mode, and may provide a digital input 706 to the ET DAC 218 representative of the requisite DC voltage reference for the ET power supply 220.

Any other DC reference 708 may provide the DC input to the ET power supply 220. Thus, as another example, the DC reference 708 may be a lower power DAC 710 that is selectively enabled by the mode selection signal 312. There may be a large capacitor 712 on the output of the lower power DAC 710 to improve spot noise to any desired level or criteria. Furthermore, the low power DAC 710 may also receive a digital input 714 representative of the DC level needed from the output of the lower power DAC 710.

As explained above, the ET path 250 transitions to a lower power mode for certain UE 100 output powers. The transition may include taking an action that reduces power of any part of the ET path 250. Examples of actions include reducing currents such as bias currents or quiescent currents, reducing switching frequencies, powering down, disabling, or placing in low power standby mode, selected components of the ET path 250. Other actions include enabling or switching to lower power components in the ET path 250, e.g., by enabling a low power DAC or programmable voltage source to provide a DC reference to the ET power supply 220.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A system comprising:
a power supply comprising a voltage output and a reference signal input;
a power supply path that drives the reference signal input; and
a controller operable to:
determine to place the power supply in a low power mode;
set the power supply to the low power mode; and
implement a power reduction action in the power supply path in response to determining to place the power supply in low power mode.

2. The system of claim 1, where the power reduction action comprises placing a component in the power supply path into a reduced power mode.

3. The system of claim 1, where the power supply comprises an envelope tracking power supply.

4. The system of claim 3, where the envelope tracking power supply is operable, in the low power mode, to output a direct current (DC) voltage on the voltage output.

5. The system of claim 4, where the power reduction action comprises activating a low power digital to analog converter (DAC) to drive the reference signal input and disabling a higher power DAC that drives the reference signal input when the power supply is not in the low power mode.

6. The system of claim 4, where the power reduction action comprises writing a DC output level to the power supply, and powering down a component in the power supply path.

7. The system of claim 6, where the component comprises a digital to analog converter (DAC) operable to drive the reference signal input when the power supply is not in the low power mode.

8. A method comprising:
generating, with a power converter, an output power supply voltage that tracks an input signal envelope of an input signal when the power converter is operating in a high power mode of operation;
generating the input signal for the power converter using components in an envelope tracking path preceding the power converter;
switching the power converter to a low power mode of operation; and
placing at least one of the components in the envelope tracking path into a reduced power mode of operation responsive to switching the power converter to the low power mode.

9. The method of claim 8, further comprising:
generating a DC output power supply voltage with the power converter when it is in the low power mode.

10. The method of claim 9, where placing comprises:
suspending operation of a first digital to analog converter (DAC) that generates the input signal.

11. The method of claim 10, further comprising:
enabling a second DAC with lower power consumption than the first DAC.

12. The method of claim 10, further comprising:
enabling a second DAC with lower power consumption than the first DAC and generating with the second DAC a DC voltage as the input signal.

13. The method of claim 8, where placing comprises:
suspending operation of a shaping table, a modulus section, or both.

14. A system comprising:
a controller that determines whether to operate in a first mode or a second mode of operation;
envelope circuitry operable to, while in the first mode, convert an input signal to an envelope signal; and
a power supply operable to generate a power supply voltage output in both the first mode and the second mode of operation, where:
while the power supply is in the first mode, the power supply is operable to generate a power supply voltage output that follows the envelope signal; and
while the power supply is in the second mode, the envelope circuitry is configured to operate according to a reduced resource requirement in comparison to its operation while the power supply is in the first mode.

15. The system of claim 14, where the reduced resource requirement comprises a lower bandwidth when compared to operating in the first mode.

16. The system of claim 14, where the reduced resource requirement comprises reduced average power compared to operating in the first mode.

17. The system of claim 14, where the envelope circuitry comprises a digital to analog converter that is operable to shut down when the power converter is in the second mode.

18. The system of claim 14, where the envelope circuitry comprises:
a first digital to analog converter operable to convert the input signal to the envelope signal when the power supply is in the first mode; and
a second digital to analog converter operable to convert the input signal to a direct current (DC) reference signal for the power supply when the power supply is in the second mode.

19. The system of claim 14, where the power supply, while operating in the second mode, is operable to generate the power supply voltage output as a direct current (DC) voltage output.

20. The system of claim 19, where:
the envelope circuitry is configured to operate according to a reduced resource requirement responsive to a mode selection signal from the controller.
